(19) United States
(12) Patent Application Publication
(10) Pub. No.: US 2025/0273397 A1
(43) Pub. Date: Aug. 28, 2025

(54) CHIP-TYPE ELECTRONIC COMPONENT

(71) Applicant: TDK Corporation, Tokyo (JP)

(72) Inventors: Ryo KONNO, Tokyo (JP); Yoshitaka NAGASHIMA, Tokyo (JP); Keiichi TAKIZAWA, Tokyo (JP); Toshihiro IGUCHI, Tokyo (JP); Shogo SASAKI, Tokyo (JP); Naruya HIGASHIURA, Tokyo (JP)

(73) Assignee: TDK Corporation, Tokyo (JP)

(21) Appl. No.: 18/973,378

(22) Filed: Dec. 9, 2024

(30) Foreign Application Priority Data
Feb. 27, 2024 (JP) 2024-027300

(51) Int. Cl. H01G 4/232; H01G 4/30

(52) U.S. Cl. CPC H01G 4/232; H01G 4/30

(57) ABSTRACT

A chip-type electronic component includes: an element body in which dielectric layers and internal electrodes are alternately stacked; and a pair of external electrodes respectively provided on a pair of end surfaces of the element body and electrically connected to the internal electrodes, and in the element body, surface roughness of a side surface connecting the pair of end surfaces is 3.0 μm or more and 7.0 μm or less.

### CROSS-REFERENCE TO RELATED APPLICATIONS

This application is based upon and claims the benefit of priority from Japanese Patent Application No. 2024-027300, filed on Feb. 27, 2024, the entire contents of which are incorporated herein by reference.

### TECHNICAL FIELD

The present disclosure relates to a chip-type electronic component.

### BACKGROUND

As a conventional chip-type electronic component, there is known one having a configuration including a ceramic element body and a pair of external electrodes respectively provided on a pair of end surfaces of the ceramic element body (see, for example, Japanese Unexamined Patent Publication No. H10-163062). In an element body of the conventional chip-type electronic component, a plurality of dielectric layers and a plurality of internal electrodes are alternately stacked. End portions of the plurality of internal electrodes are exposed from end surfaces of the element body and are electrically connected to the external electrodes.

In manufacturing of the chip-type electronic component, first, there is formed a stacked body in which ceramic green sheets including a dielectric material and ceramic green sheets with internal electrodes formed by printing or the like are alternately stacked. Next, the stacked body is cut to obtain a green chip and then the green chip is fired to obtain an element body. After the formation of the element body, the end surface of the element body is polished by barrel polishing so that the end portion of the internal electrode is exposed from the end surface of the element body. Thereafter, the external electrode is formed on the end surface of the element body by plating or the like, thereby obtaining the chip-type electronic component.

### SUMMARY

When the appearance of the chip-type electronic component obtained through steps described above is observed, there may occur a crack in the element body, which starts from slight chipping or the like present on a surface of the element body. From the viewpoint of sufficiently securing the reliability of the chip-type electronic component, a technique capable of suppressing the occurrence of such a crack is desired.

The present disclosure has been made to solve the above-described problem, and an object of the present disclosure is to provide a chip-type electronic component capable of suitably suppressing the occurrence of a crack starting from a surface of an element body.

The gist of the present disclosure is as follows.

[1] A chip-type electronic component including: an element body in which dielectric layers and internal electrodes are alternately stacked; and a pair of external electrodes respectively provided on a pair of end surfaces of the element body and electrically connected to the internal electrodes, in which in the element body, surface roughness RSm of a side surface connecting the pair of end surfaces is 3.0 μm or more and 7.0 μm or less.

In the element body in this chip-type electronic component, the surface roughness RSm of the side surface connecting the pair of end surfaces is 3.0 μm or more and 7.0 μm or less. In a case where the surface roughness RSm is smaller than 3.0 μm, surface irregularities due to roughness tend to be sharp, and in a case where the surface roughness RSm is larger than 7.0 μm, surface irregularities due to roughness tend to be large. The surface roughness RSm is set to 3.0 μm or more and 7.0 μm or less, whereby both the sharpness and the size of the surface irregularities due to roughness are alleviated, and the occurrence of the crack starting from the surface of the element body can be suitably suppressed.

[2] The chip-type electronic component according to [1], in which the surface roughness RSm of the side surface is 4.0 μm or more and 6.0 μm or less. When the surface roughness RSm satisfies this range, both the sharpness and the size of the surface irregularities due to roughness are further alleviated, and the occurrence of the crack starting from the surface of the element body can be more reliably suppressed.

[3] The chip-type electronic component according to [1] or [2], in which surface roughness Ra of the side surface is 0.075 μm or less. When the surface roughness Ra satisfies this range, sharpness of surface irregularities due to roughness is further alleviated, and the occurrence of the crack starting from the surface of the element body can be more reliably suppressed.

[4] The chip-type electronic component according to any one of [1] to [3], in which the surface roughness Ra of the side surface is 0.005 μm or more. When the surface roughness Ra satisfies this range, it is possible to prevent the adhesion of the external electrode to the element body from being hindered.

[5] The chip-type electronic component according to any one of [1] to [4], in which Si segregation is present on a surface of the side surface. According to such a configuration, the occurrence of the crack starting from the surface of the element body can be more effectively suppressed by the Si segregation. In addition, even if the crack starting from the surface of the element body occurs, the progress of the crack is suppressed.

[6] The chip-type electronic component according to [5], in which the element body has a capacitance forming portion in which the internal electrodes overlap each other in a stacking direction and a gap portion in which the internal electrodes do not overlap each other in the stacking direction, and the number of spots of the Si segregation present per unit area in the gap portion is larger than the number of spots of the Si segregation present per unit area in the capacitance forming portion. With such a configuration, since a large amount of the Si segregation is present in the gap portion of the element body, it is possible to more effectively suppress the occurrence and progress of the crack starting from the surface of the element body.

[7] The chip-type electronic component according to [6], in which the number of spots of the Si segregation present per unit area in the gap portion is four times or more larger than the number of spots of the Si segregation present per unit area in the capacitance forming portion. In this case, the presence of more Si segregation in the gap portion of the element body makes it possible to more effectively suppress the occurrence and progress of the crack starting from the surface of the element body.

### BRIEF DESCRIPTION OF THE DRAWINGS

FIG. 1 is a perspective view illustrating a chip-type electronic component according to an embodiment of the present disclosure;

FIG. 2 is a schematic longitudinal sectional view of the chip-type electronic component;

FIG. 3 is a schematic transverse sectional view of the chip-type electronic component;

FIG. 4 is a flowchart illustrating an example of a method of manufacturing the chip-type electronic component;

FIG. 5 is a schematic perspective view illustrating an example of a crack that starts from a surface of an element body and that can occur in a general chip-type electronic component;

FIG. 6A is a graph illustrating a definition of surface roughness RSm;

FIG. 6B is a graph illustrating a definition of surface roughness Ra;

FIG. 7 is a schematic view illustrating a relationship between the surface roughness RSm, the surface roughness Ra, and a surface state of an element body;

FIG. 8 is a schematic view illustrating segregation of a surface of the element body;

FIG. 9A is a schematic perspective view illustrating a method of measuring surface roughness of a side surface of an element body in each sample;

FIG. 9B is a table illustrating a determination result of a rate of occurrence of a crack starting from a surface in each sample;

FIG. 10A is a schematic view illustrating a measurement position of Si segregation in each sample; and

FIG. 10B is a view illustrating the determination result of a rate of occurrence of a crack starting from a surface with respect to the number of spots of the Si segregation present.

### DETAILED DESCRIPTION

Hereinafter, a preferred embodiment of an electronic component according to an aspect of the present disclosure will be described in detail with reference to the drawings.

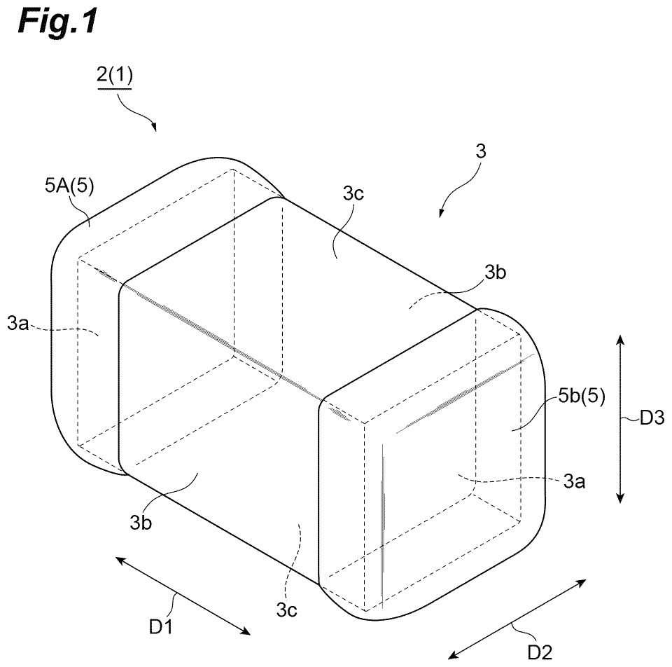

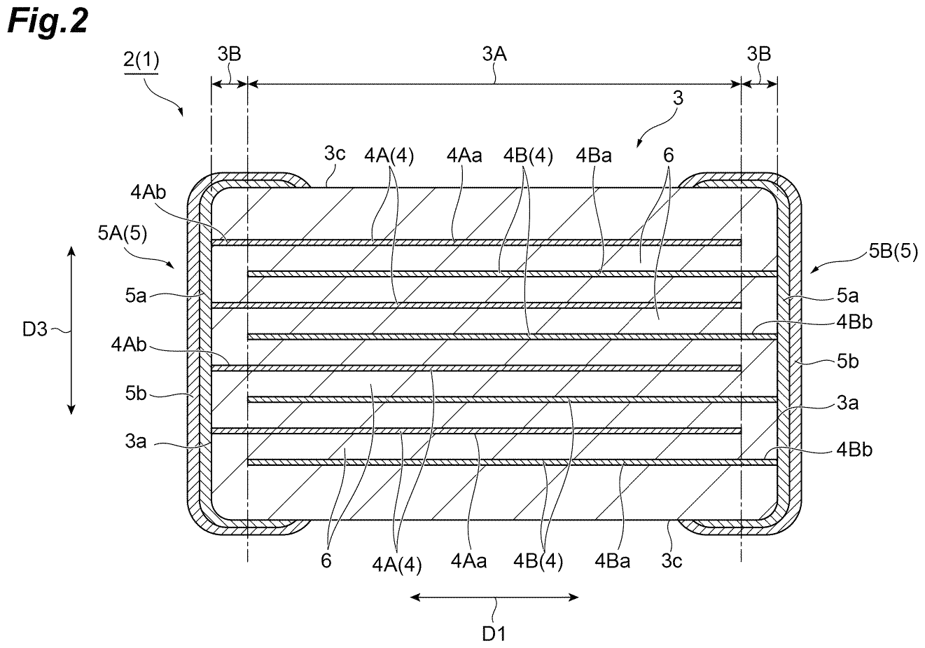

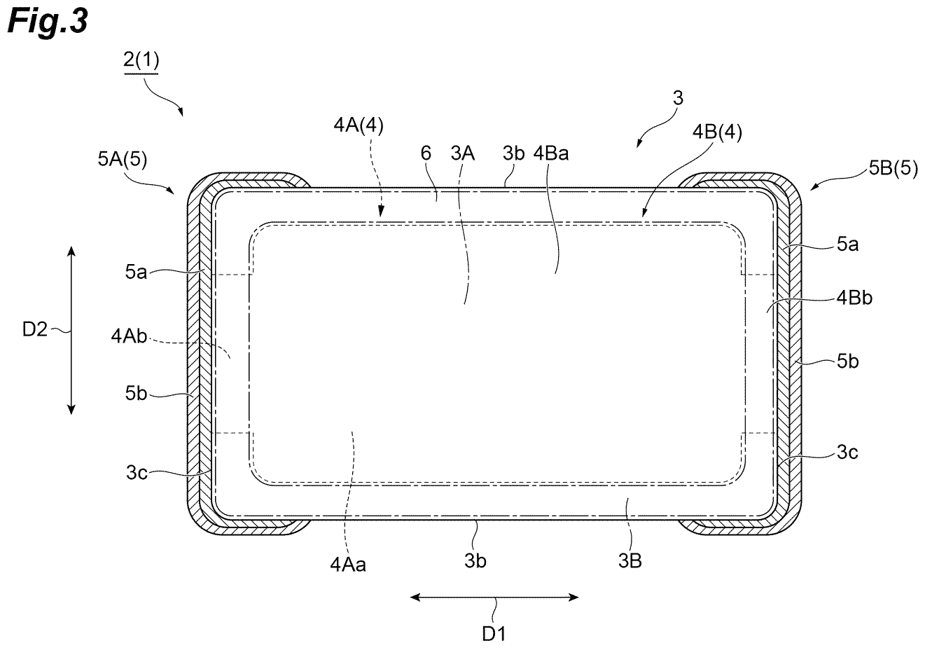

FIG. 1 is a perspective view illustrating a chip-type electronic component 1 according to an embodiment of the present disclosure. FIG. 2 is a schematic longitudinal sectional view of the chip-type electronic component 1, and FIG. 3 is a schematic transverse sectional view thereof. As the chip-type electronic component 1 illustrated in FIGS. 1 to 3, a multilayer ceramic capacitor 2 is exemplified. The multilayer ceramic capacitor 2 includes an element body 3, a plurality of internal electrodes 4 (see FIGS. 2 and 3), and a pair of external electrodes 5. In the following description, for convenience, a first direction D1, a second direction D2, and a third direction D3 orthogonal to each other are defined. The first direction D1 corresponds to a length direction of the element body 3, the second direction D2 corresponds to a width direction of the element body 3, and the third direction D3 corresponds to a height direction of the element body 3.

The element body 3 has, for example, a rectangular parallelepiped shape. The rectangular parallelepiped shape includes a shape in which corner portions and ridge portions are chamfered and a shape in which corner portions and ridge portions are rounded. The element body has a pair of end surfaces 3a, a pair of side surfaces 3b, and a pair of side surfaces 3c. In the present embodiment, the pair of end surfaces 3a is surfaces in the length direction of the element body 3 and faces each other in the first direction D1. The pair of side surfaces 3b and the pair of side surfaces 3c extend so as to connect the pair of end surfaces 3a. The pair of side surfaces 3b is surfaces in the width direction of the element body 3 and faces each other in the second direction D2. The pair of side surfaces 3c is surfaces in the height direction of the element body 3 and faces each other in the third direction D3.

The length of the element body 3 is, for example, 0.4 mm or more and 7.5 mm or less. The width of the element body 3 is, for example, 0.2 mm or more and 6.3 mm or less. The height of the element body 3 is, for example, 0.2 mm or more and 2.8 mm or less. As an example, in the present embodiment, the length of the element body 3 is 3.2 mm, the width of the element body 3 is 2.5 mm, and the height of the element body 3 is 2.5 mm.

The element body 3 is formed by stacking a plurality of dielectric layers 6. In the present embodiment, the plurality of dielectric layers 6 is stacked in the third direction D3. Each dielectric layer 6 includes, for example, a sintered body of a ceramic green sheet. The ceramic green sheet includes, for example, a dielectric material. Examples of the dielectric material include BaTiO₃-based, Ba(Ti, Zr) O₃-based, (Ba, Ca) TiO₃-based, (Ba, Ca)(Ti, Zr) O₃-based, CaZrO₃-based, and (Ca, Sr) ZrO₃-based dielectric ceramics. In the element body 3, the respective dielectric layers 6 are integrated to such an extent that a boundary between the dielectric layers 6 cannot be visually recognized.

The internal electrode 4 is an internal conductor disposed in the element body 3. The internal electrodes 4 are alternately stacked with the dielectric layers 6 in the third direction D3. Examples of a conductive material constituting the internal electrode 4 include Cu and Ni. The internal electrode 4 may include the same conductive material as the conductive material included in the external electrode 5. The internal electrode 4 may include a conductive material different from the conductive material included in the external electrode 5. The internal electrode 4 is formed as a sintered body of a conductive paste including the above-described conductive material.

In the present embodiment, as illustrated in FIGS. 2 and 3, the internal electrode 4 has an internal electrode 4A led out to one of the pair of end surfaces 3a and an internal electrode 4B led out d to the other of the pair of end surfaces 3a. The internal electrodes 4A and the internal electrodes 4B are alternately disposed in the third direction D3.

The internal electrode 4A has a main electrode portion 4Aa and a lead-out electrode portion 4Ab. When viewed from the third direction D3, the main electrode portion 4Aa has, for example, a rectangular shape slightly smaller than the element body 3. The lead-out electrode portion 4Ab extends with a width smaller than that of the main electrode portion 4Aa toward one of the pair of end surfaces 3a. An end portion of the lead-out electrode portion 4Ab is exposed to one of the pair of end surfaces 3a and is electrically connected to one of the pair of external electrodes 5.

The internal electrode 4B has a main electrode portion 4Ba and a lead-out electrode portion 4Bb. When viewed from the third direction D3, the main electrode portion 4Ba has, for example, a rectangular shape having the same dimension as that of the main electrode portion 4Aa and overlaps the main electrode portion 4Aa with the dielectric layer 6 interposed therebetween. The lead-out electrode portion 4Bb extends with a width smaller than that of the main electrode portion 4Ba toward the other of the pair of end surfaces 3a. An end portion of the lead-out electrode portion 4Bb is exposed to the other of the pair of end surfaces 3a and is electrically connected to the other of the pair of external electrodes 5.

In the present embodiment, in the element body 3, a portion where the internal electrodes 4 overlap each other in the third direction D3 is referred to as a capacitance forming portion 3A, and a portion where the internal electrodes 4 do not overlap each other in the third direction D3 is referred to as a gap portion 3B (see FIGS. 2 and 3). When viewed from the third direction D3, the capacitance forming portion 3A is a portion where the main electrode portion 4Aa of the internal electrode 4A and the main electrode portion 4Ba of the internal electrode 4B are located, and the capacitance forming portion 3A is located inside the element body 3. When viewed from the third direction D3, the gap portion 3B is a portion where the main electrode portion 4Aa of the internal electrode 4A and the main electrode portion 4Ba of the internal electrode 4B are not located, and the gap portion 3B is located on a surface side of the element body 3 so that the gap portion 3B surrounds the capacitance forming portion 3A.

The external electrode 5 is an external conductor disposed outside the element body 3. The external electrode 5 has an external electrode 5A covering one of the pair of end surfaces 3a and an external electrode 5B covering the other of the pair of end surfaces 3a (see FIGS. 2 and 3). A part of the external electrode 5A may wrap around each of the pair of side surfaces 3b and the pair of side surfaces 3c from one of the pair of end surfaces 3a. Similarly, a part of the external electrode 5B may wrap around each of the pair of side surfaces 3b and the pair of side surfaces 3c from the other of the pair of end surfaces 3a.

As illustrated in FIGS. 2 and 3, each of the external electrode 5A and the external electrode 5B includes a first electrode layer 5a and a second electrode layer 5b. In examples of FIGS. 2 and 3, in each of the external electrode 5A and the external electrode 5, both a portion covering the end surface 3a and a portion wrapping around the side surfaces 3b and 3c include the first electrode layer 5a and the second electrode layer 5b. The first electrode layer 5a is an inner layer (on a side of the element body 3), and the second electrode layer 5b is an outer layer (on a side opposite to the element body 3). In the present embodiment, the second electrode layer 5b constitutes the outermost layer of the external electrode 5.

The first electrode layer 5a is formed, for example, by baking a conductive paste applied to a surface of the element body 3. The above-described conductive paste includes, for example, a resin, a plurality of glass particles, a plurality of metal particles, and an organic solvent. The resin includes, for example, an acrylic resin or ethyl cellulose. The above-described plurality of metal particles includes, for example, Cu particles or Ni particles.

The second electrode layer 5b is a plated layer formed on the first electrode layer 5a by, for example, a plating method. In the present embodiment, the second electrode layer 5b is formed so as to cover the entire first electrode layer 5a. The second electrode layer 5b may be a Ni plated layer. The second electrode layer 5b may include a Ni plated layer and a Sn plated layer formed on the Ni plated layer.

Next, a method of manufacturing the chip-type electronic component 1 described above will be described.

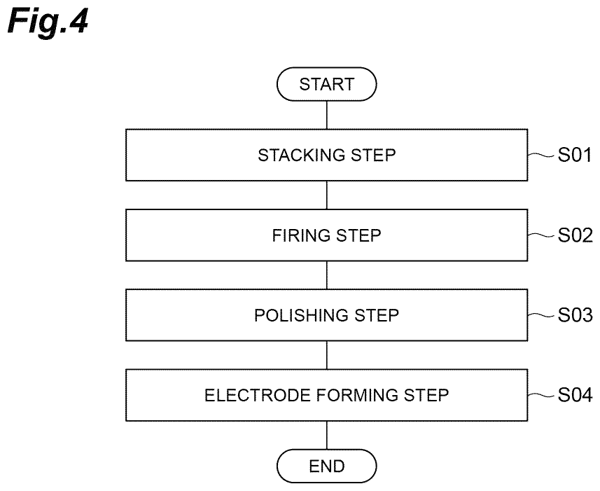

FIG. 4 is a flowchart illustrating an example of the method of manufacturing the chip-type electronic component 1. As illustrated in FIG. 4, the method of manufacturing the chip-type electronic component 1 includes a stacking step S01, a firing step S02, a polishing step S03, and an electrode forming step S04.

The stacking step S01 is a step of forming a green chip to be a basis material of the element body 3. In the stacking step S01, a ceramic green sheet to be the dielectric layer 6, a ceramic green sheet on which a pattern of the internal electrode 4A is printed using a conductive paste, and a ceramic green sheet on which a pattern of the internal electrode 4B is printed using a conductive paste are prepared. Next, these green sheets are stacked in predetermined order to form a stacked body. The formed stacked body is cut to obtain the green chip to be the basis material of the element body 3.

The firing step S02 is a step of firing the green chip to obtain the element body 3. In the firing step S02, the obtained green chip is fired at a predetermined temperature to obtain the element body 3. After the firing step S02, annealing processing for removing residual stress of the element body 3 may be performed.

The polishing step S03 is a step of polishing the surface of the element body 3. In the polishing step S03, the surface of the element body 3 is polished by, for example, barrel polishing, and the internal electrode 4 is exposed from the pair of end surfaces 3a of the element body 3. In the polishing step S03, the lead-out electrode portion 4Ab of the internal electrode 4A is exposed from one of the pair of end surfaces 3a of the element body 3, and the lead-out electrode portion 4Bb of the internal electrode 4B is exposed from the other of the pair of end surfaces 3a of the element body 3.

In the present embodiment, wet barrel polishing is performed as the barrel polishing. In the wet barrel polishing, for example, a sealed rotary pot made of a material such as polyethylene is used. The plurality of element bodies 3 is placed in the sealed rotary pot together with a solvent, a medium, an abrasive material, and the like, and the sealed rotary pot is rotated. As a result, the surface of the element body 3 is polished, and the internal electrode 4 is exposed from the pair of end surfaces 3a of the element body 3. In addition, corners of the element body 3 are chamfered, so that the corners of the element body 3 have rounded shapes.

In the electrode forming step S04, the external electrode 5 is formed at an end portion of the element body 3. In the electrode forming step S04, for example, a conductive paste including metal powder including Cu as a main component is prepared. Next, each of end portions on sides of the pair of end surfaces 3a of the element body 3 is immersed in the conductive paste, and a paste layer is formed at the end portion. Then, the paste layer is heat-treated at a predetermined temperature, whereby the first electrode layer 5a is formed. After the formation of the first electrode layer 5a, a Ni plated layer is deposited on the first electrode layer 5a by, for example, a plating method, and the second electrode layer 5b is formed. In addition, a Sn plated layer is further formed on the Ni plated layer as necessary. As a result, the chip-type electronic component 1 illustrated in FIGS. 1 to 3 is obtained.

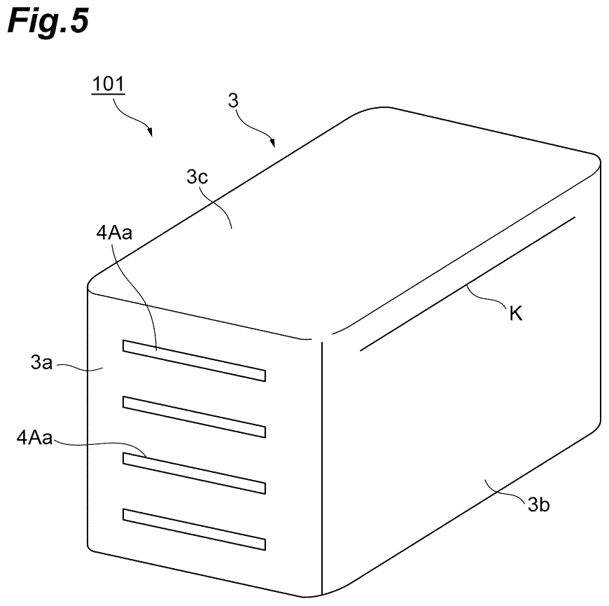

FIG. 5 is a perspective view schematically illustrating the appearance of a general chip-type electronic component 101 obtained in a manufacturing steps as described above. In FIG. 5, for convenience, an element body 3 is illustrated from one side of a pair of end surfaces 3a with an external electrode 5 removed. When the appearance of the general chip-type electronic component 101 after being manufactured is observed, as illustrated in FIG. 5, a crack K starting from slight chipping or the like present on a surface of the element body 3 may occur in the element body 3. When such a crack K starting from the surface of the element body 3 progresses to the surface or the inside of the element body 3, there is a possibility that reliability as a product is deteriorated.

With respect to such a problem, in the chip-type electronic component 1, surface roughness RSm and Ra of the side surfaces 3b and 3c of the element body 3 are defined, whereby the presence of the starting point of the crack K on the surface of the element body 3 is suppressed, and the occurrence of the crack K starting from the surface of the element body 3 is suppressed. More specifically, in the element body 3 in the chip-type electronic component 1, the surface roughness RSm of the side surfaces 3b and 3c connecting the pair of end surfaces 3a is 3.0 μm or more and 7.0 μm or less and preferably 4.0 μm or more and 6.0 μm or less. In addition, in the element body 3, the surface roughness Ra of the side surfaces 3b and 3c connecting the pair of end surfaces 3a is 0.075 μm or less and preferably 0.005 μm or more.

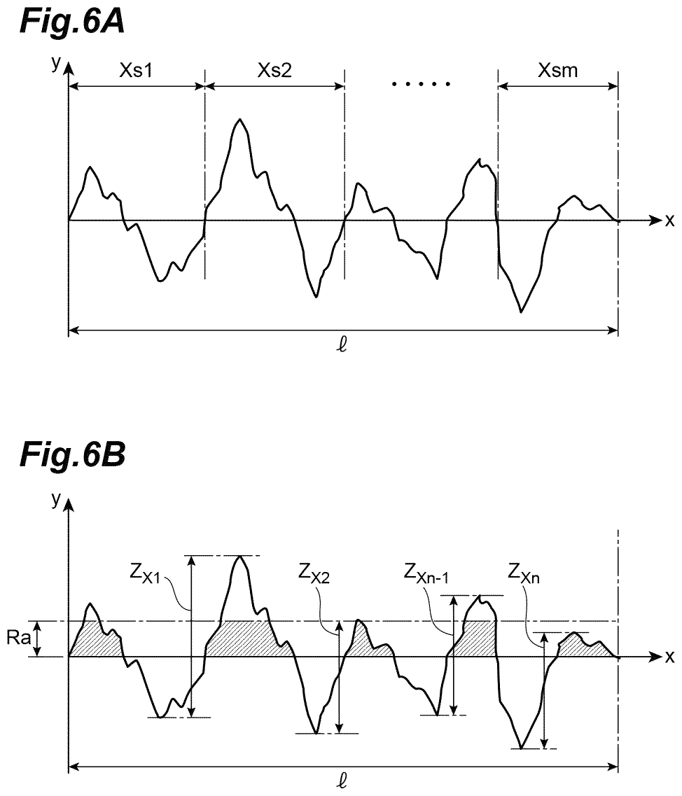

Here, definitions of the surface roughness RSm and the surface roughness Ra follow JISB 0601:2013. As illustrated in FIG. 6A, the surface roughness RSm is a parameter representing an average length of lengths of contour curves at a reference length l. The surface roughness RSm can be calculated by the following Formula (1) in a case where a length of a contour curve of one section within the reference length l is XSi. In addition, as illustrated in FIG. 6B, the surface roughness Ra is a parameter representing arithmetic average roughness of the contour curve at the reference length l. The surface roughness Ra can be calculated by the following Formula (2) in a case where a height (ordinate value) of the contour curve at any position x is Z(x).

$$\begin{matrix}[ Formula 1 ] & \\ RSm = \frac{1}{m} {\sum }_{i = 1}^{m} XSi & ( 1 )\end{matrix}$$

$$\begin{matrix}[ Formula 2 ] & \\ Ra = \frac{1}{l} {\int }_{0}^{l} \vert Z ( x ) \vert dx & ( 2 )\end{matrix}$$

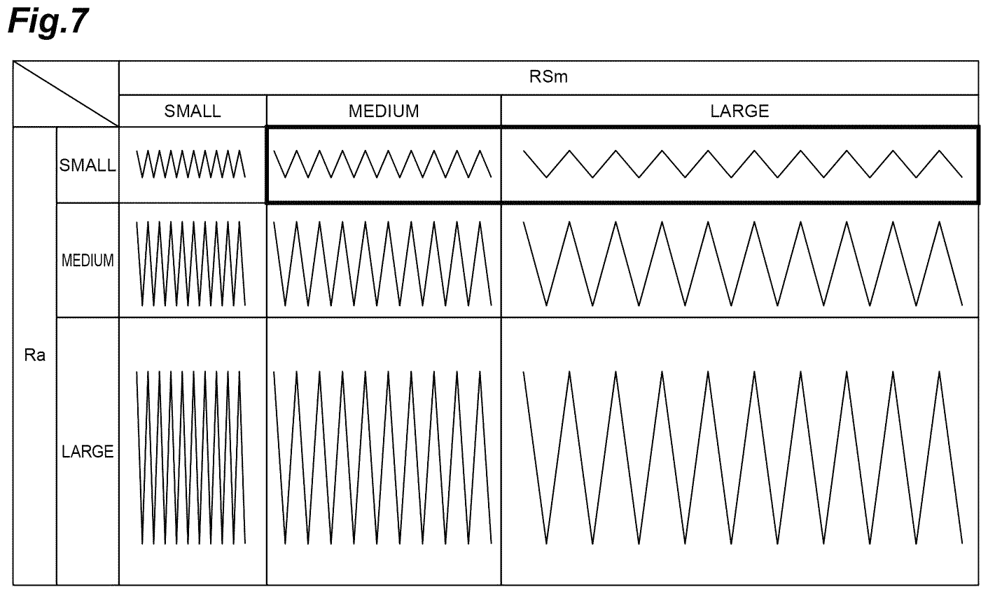

FIG. 7 is a schematic view illustrating a relationship between the surface roughness RSm, the surface roughness Ra, and the surface state of the element body. As illustrated in FIG. 7, the surface roughness RSm is related to the periodicity of the surface irregularities of the element body 3. When the surface roughness RSm becomes small, a cycle of the irregularities tends to be short and the irregularities tend to be sharp. When the surface roughness RSm becomes large, the cycle of the irregularities tends to be long and the irregularities tend to be large. In addition, the surface roughness Ra is related to a depth of the surface irregularities of the element body 3. As the surface roughness Ra becomes small, the depth of the irregularities tends to be small, and the sharpness of the irregularities tends to be alleviated. In the chip-type electronic component 1, as illustrated by a thick frame portion in FIG. 7, the surface roughness RSm on the side surfaces 3b and 3c of the element body 3 is secured in a certain range, and the surface roughness Ra is more preferably reduced, thereby alleviating both the sharpness and the size of the irregularities of the side surfaces 3b and 3c.

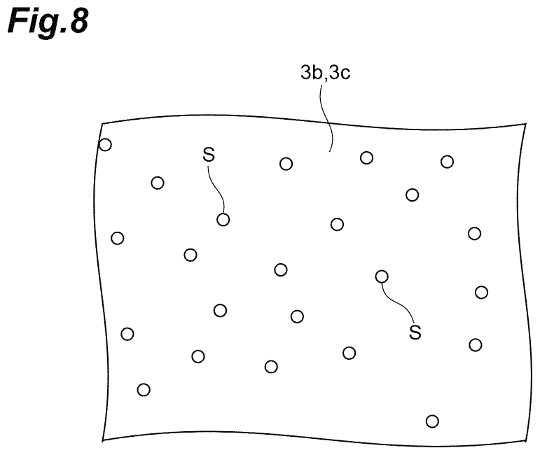

In addition, as illustrated in FIG. 8, in the chip-type electronic component 1, Si segregation S is present on the surfaces of the side surfaces 3b and 3c of the element body 3. Segregation is a phenomenon in which an element of a metal or an alloy is unevenly distributed due to separation of a substance from one phase to another phase when the substance undergoes phase transition. The presence of the Si segregation S on the surfaces of the side surfaces 3b and 3c of the element body 3 makes it possible to more effectively suppress the occurrence of the crack K starting from the surface of the element body 3. In addition, even in a case where the crack K starting from the surface of the element body 3 occurs, the Si segregation S suppresses the progress of the crack K.

In the present embodiment, for example, the green chip to be the basis material of the element body 3 is immersed in a solution including Si before being fired and then the green chip is fired. As a result, the number of spots of Si segregation S present per unit area in the gap portion 3B is larger than the number of spots of Si segregation S present per unit area in the capacitance forming portion 3A. The number of spots of Si segregation S present per unit area in the gap portion 3B is preferably four times or more larger than the number of spots of Si segregation S present per unit area in the capacitance forming portion 3A. The unit area is not particularly limited, but for example, a rectangular range of 100 μm×100 μm needs to be set at any position on the side surfaces 3b and 3c of the element body 3.

As described above, in the element body 3 in the chip-type electronic component 1, the surface roughness RSm of the side surfaces 3b and 3c connecting the pair of end surfaces 3a is 3.0 μm or more and 7.0 μm or less. In a case where the surface roughness RSm is smaller than 3.0 μm, surface irregularities due to roughness tend to be sharp, and in a case where the surface roughness RSm is larger than 7.0 μm, surface irregularities due to roughness tend to be large. The surface roughness RSm is set to 3.0 μm or more and 7.0 μm or less, whereby both the sharpness and the size of the surface irregularities due to roughness are alleviated, and the occurrence of the crack K starting from the surface of the element body 3 can be suitably suppressed.

In the present embodiment, the surface roughness RSm of the side surfaces 3b and 3c is 4.0 μm or more and 6.0 μm or less. When the surface roughness RSm satisfies this range, both the sharpness and the size of the surface irregularities due to roughness are further alleviated, and the occurrence of the crack K starting from the surface of the element body 3 can be more reliably suppressed.

In the present embodiment, the surface roughness Ra of the side surfaces 3b and 3c is 0.075 μm or less. When the surface roughness Ra satisfies this range, the sharpness of the surface irregularities due to roughness is further alleviated, and the occurrence of the crack K starting from the surface of the element body 3 can be more reliably suppressed. In addition, in the present embodiment, the surface roughness Ra of the side surfaces 3b and 3c is 0.005 μm or more. When the surface roughness Ra satisfies this range, it is possible to suppress that the adhesion of the external electrode 5 to the element body 3 is inhibited.

In the present embodiment, the Si segregation S is present on the surfaces of the side surfaces 3b and 3c. With such a configuration, the Si segregation S can more effectively suppress the occurrence of the crack K starting from the surface of the element body 3. In addition, even if the crack starting from the surface of the element body 3 occurs, the progress of the crack K is suppressed.

In the present embodiment, the number of spots of Si segregation S present per unit area in the gap portion 3B is larger than the number of spots of Si segregation S present per unit area in the capacitance forming portion 3A. In addition, preferably, the number of spots of Si segregation S present per unit area in the gap portion 3B is four times or more larger than the number of spots of Si segregation S present per unit area in the capacitance forming portion 3A. With such a configuration, since a large amount of Si segregation is present in the gap portion 3B of the element body 3, it is possible to more effectively suppress the occurrence and progress of the crack K starting from the surface of the element body 3.

### Example

Hereinafter, an example of the present disclosure will be described.

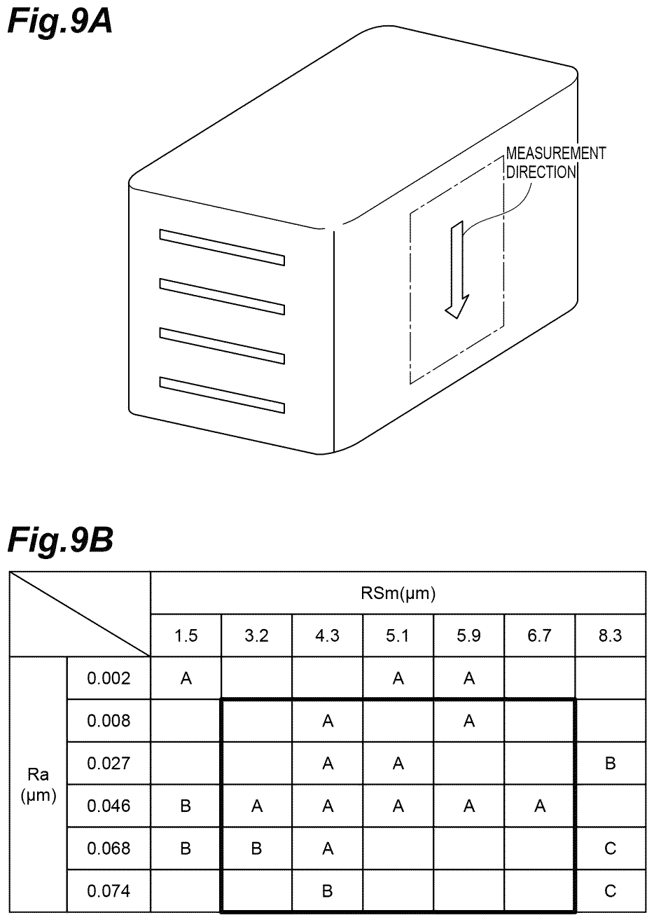

First, as illustrated in FIG. 9A, samples of an element body, which have different surface roughness RSm and Ra were prepared, and the surface roughness of a side surface (surface corresponding to the side surface 3b) of the element body in each sample was measured.

For the measurement of the surface roughness RSm and Ra, a laser microscope was used. A measurement range was a rectangular range of 500 μm×500 μm on the side surface of the element body, and a measurement direction was matched with a stacking direction of a dielectric layer in the element body. The measurement results of the surface roughness RSm in the samples were seven types of 1.5 μm, 3.2 μm, 4.3 μm, 5.1 μm, 6.7 μm, and 8.3 μm. In addition, the measurement results of the surface roughness Ra in the samples were six types of 0.002 μm, 0.008 μm, 0.027 μm, 0.046 μm, 0.068 μm, and 0.074 μm.

Next, the appearance of each of the prepared samples was observed using a stereoscopic microscope, and the presence or absence of a crack was confirmed. For a sample in which the occurrence of a crack was confirmed, a crack surface was peeled and details were observed, whereby a starting point was identified, and cracks are classified into a crack starting from a surface of the element body and a crack starting from a portion other than the surface of the element body. Then, a rate of occurrence of a crack starting from the surface of the element body was calculated on the basis of the number of samples in which a crack starting from the surface of the element body occurred among 100 samples in which a crack occurred.

FIG. 9B is a table illustrating a determination result of a rate of occurrence of a crack starting from the surface of the element body in each sample. In FIG. 9B, a case where the rate of occurrence of a crack starting from the surface of the element body was 0% or more and less than 30% was determined as “A”, a case where the rate of occurrence of a crack starting from the surface of the element body was 30% or more and less than 70% was determined as “B”, and a case where the rate of occurrence of a crack starting from the surface of the element body was 70% or more and 100% or less was determined as “C”.

From the results illustrated in FIG. 9B, it was confirmed that in each sample having surface roughness RSm of 3.0 μm or more and 7.0 μm or less, the determination of the rate of occurrence of a clack starting from the surface of the element body was “A” or “B”, and the rate of occurrence of a crack starting from the surface of the element body decreased as compared with each sample having surface roughness RSm of less than 3.0 μm and more than 7.0 μm. It was confirmed that in a range (thick frame portion in FIG. 9B) in which the surface roughness Ra satisfies 0.005 μm or more and 0.075 μm or less in each sample having surface roughness RSm of 3.0 μm or more and 7.0 μm or less, the determination of the rate of occurrence of a crack starting from the surface of the element body was almost “A”, and the rate of occurrence of a crack starting from the surface of the element body further decreased.

Subsequently, a relationship between the number of spots of the Si segregation present on the surface of the element body and the rate of occurrence of a crack starting from the surface of the element body was evaluated. In this evaluation, a green chip to be a basis material of the element body was immersed in a solution including Si before being fired and then the green chip was fired to form a plurality of samples of the element body. In the measurement of the number of spots of the Si segregation present, the element body of each sample was polished up to the vicinity of the center from one end surface to the other end surface so that the cross section of a capacitance forming portion was exposed.

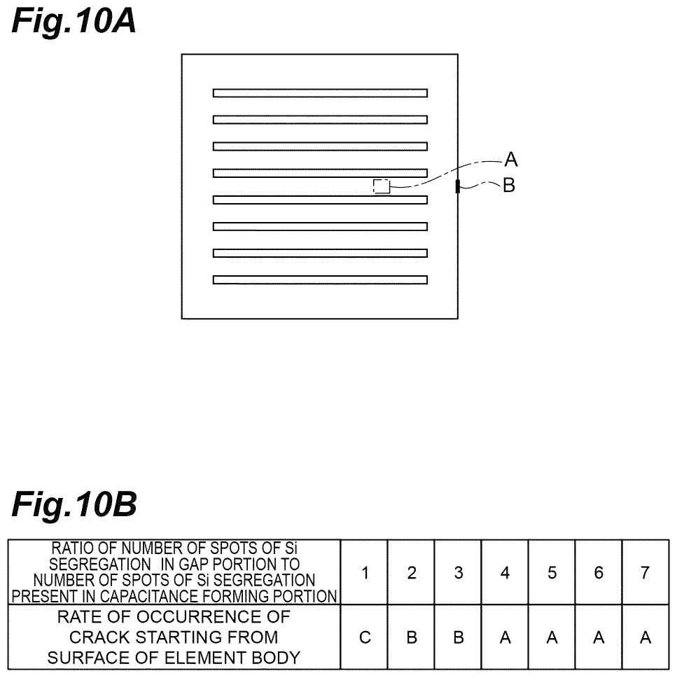

With respect to the polished sample, as illustrated in FIG. 10A, a cross section A of the capacitance forming portion and a surface B of a gap portion were observed using an electron beam microanalyzer, and a portion where the intensity of a characteristic X-ray acquired by the electron beam microanalyzer exceeded an average value +5σ (σ is standard deviation) was defined as a position at which Si segregation is present. A measurement range was a rectangular range of 100 μm×100 μm in both the capacitance forming portion and the gap portion.

When the number of spots of the Si segregation present within the measurement range in the capacitance forming portion and the gap portion of one sample among the above-described plurality of samples was measured, the number of spots was 7.8 in the capacitance forming portion, whereas the number of spots was 46.9 in the gap portion. Therefore, as described above, it was confirmed that the green chip to be the basis material of the element body is immersed in the solution including Si before being fired and then the green chip is fired, whereby the number of spots of the Si segregation present per unit area in the gap portion can be made larger than the number of spots of the Si segregation present per unit area in the capacitance forming portion.

FIG. 10B is a table illustrating a determination result of the rate of occurrence of a crack starting from the surface with respect to the number of spots of the Si segregation present. Here, for a sample having surface roughness RSm of 4.3 μm and surface roughness Ra of 0.074 μm, a ratio of the number of spots of the Si segregation present in the gap portion to the number of spots of the Si segregation present in the capacitance forming portion was changed, and the rate of occurrence of a crack starting from the surface of the element body was calculated for each ratio. In FIG. 10B, a case where the rate of occurrence of a crack starting from the surface of the element body was less than 30% was determined as “A”, a case where the rate of occurrence of a crack starting from the surface of the element body was 30% or more and less than 70% was determined as “B”, and a case where the rate of occurrence of a crack starting from the surface of the element body was 70% or more was determined as “C”.

As illustrated in FIG. 10B, in a case where the ratio of the number of spots of the Si segregation present in the gap portion to the number of spots of the Si segregation present in the capacitance forming portion is 1, the determination of the rate of occurrence of a crack starting from the surface of the element body is “C”, whereas in a case where the ratio is 2 to 7, the determination of the rate of occurrence of a crack starting from the surface of the element body is “A” or “B”. In addition, in a case where the ratio is 4 or more, the determination of the rate of occurrence of a crack starting from the surface of the element body is “A”. From this result, it was confirmed that the occurrence of a crack starting from the surface of the element body can be effectively suppressed by making the number of spots of the Si segregation present per unit area in the gap portion larger than and preferably four times or more larger than the number of spots of the Si segregation present per unit area in the capacitance forming portion.

What is claimed is:

1. A chip-type electronic component comprising:
an element body in which a dielectric layer and an internal electrode are alternately stacked; and
a pair of external electrodes respectively provided on a pair of end surfaces of the element body and electrically connected to the internal electrodes, wherein
in the element body, surface roughness RSm of a side surface connecting the pair of end surfaces is 3.0 μm or more and 7.0 μm or less.

2. The chip-type electronic component according to claim 1, wherein the surface roughness RSm of the side surface is 4.0 μm or more and 6.0 μm or less.

3. The chip-type electronic component according to claim 1, wherein surface roughness Ra of the side surface is 0.075 μm or less.

4. The chip-type electronic component according to claim 1, wherein surface roughness Ra of the side surface is 0.005 μm or more.

5. The chip-type electronic component according to claim 1, wherein Si segregation is present on a surface of the side surface.

6. The chip-type electronic component according to claim 5, wherein
the element body includes a capacitance forming portion in which the internal electrodes overlap each other in a stacking direction and a gap portion in which the internal electrodes do not overlap each other in the stacking direction, and
the number of spots of the Si segregation present per unit area in the gap portion is larger than the number of spots of the Si segregation present per unit area in the capacitance forming portion.

7. The chip-type electronic component according to claim 6, wherein the number of spots of the Si segregation present per unit area in the gap portion is four times or more larger than the number of spots of the Si segregation present per unit area in the capacitance forming portion.
